(19) United States
(12) Patent Application Publication
(10) Pub. No.: US 2021/0108623 A1
(43) Pub. Date: Apr. 15, 2021

(54) BENT-AXIS AXIAL-PISTON HYDRAULIC MACHINE

(71) Applicant: DANA MOTION SYSTEMS ITALIA S.R.L., REGGIO EMILIA (IT)

(72) Inventors: ALESSANDRO SASSI, REGGIO EMILIA (IT); FABIO NATALI, MODENA (IT); FEDERICA FRANZONI, REGGIO EMILIA (IT)

(73) Assignee: DANA MOTION SYSTEMS ITALIA S.R.L., REGGIO EMILIA (IT)

(21) Appl. No.: 16/982,081

(22) PCT Filed: Mar. 20, 2019
(86) PCT No.: PCT/EP2019/056942

§ 371 Date: Sep. 18, 2020

(30) Foreign Application Priority Data
Mar. 21, 2018 (EP) 18425015.7

(51) Int. Cl. F04B 1/30; F03C 1/40; F03C 1/32; F04B 1/2035

(52) U.S. Cl. CPC F04B 1/30; F04B 1/2035; F03C 1/0652; F03C 1/0692

(57) ABSTRACT

A bent-axis axial-piston hydraulic machine may have a cylinder block being movable circumferentially about a first rotation axis. The machine may also have a transmission shaft which is functionally associated with the cylinder block and which can rotate about a transmission axis incident on the rotation axis. The machine may also have a distributor, and a device for angular offsetting which is associated with the distributor to rotate the distributor to cause a variation of effective cubic capacity while a geometric cubic capacity of the machine remains constant. The corresponding method for adjusting the capacity of a bent-axis axial piston hydraulic machine is also disclosed.

The present invention relates to a bent-axis axial-piston hydraulic machine.

The term “hydraulic machine” refers to devices that convert the kinetic energy of a liquid to mechanical energy which is collected using a shaft (hydraulic engines) or, conversely, which convert the mechanical energy provided by the shaft to kinetic energy of a liquid (hydraulic pumps).

In particular the invention relates to a bent-axis axial-piston hydraulic machine, known in the sector as a “bent axis” motor or pump.

In more detail the invention relates to a hydraulic machine according to the preamble of the first claim and a corresponding method for its adjustment, the term “adjustment” meaning preferably the variation of the operating parameters and in particular the variation of the cubic capacity of the machine.

Conventional “bent axis” machines (engines or pumps) comprise a transmission shaft that can rotate about a first rotation axis, also called the transmission axis. Such shaft is used to exert the mechanical work that results in the compression of the fluid (for pumps), or to dispense the mechanical work (for engines) produced by the pressure of the working fluid.

To this end such machines comprise a cylinder block, which can rotate about a respective second rotation axis and is associated at least in rotation with the transmission shaft.

In bent-axis machines, the first and second rotation axes are not mutually aligned (hence the name “bent axis”).

The cylinder block comprises a plurality of cylinders and cooperating pistons which are arranged circumferentially about the rotation axis of the cylinder block.

The pistons can move substantially axially in the cylinders between an upper stroke limit position and a lower stroke limit position, which are reached during rotation of the cylinder block about its own axis.

Each piston comprises a terminal end outside the respective cylinder and, between each cylinder and the terminal end inside (arranged opposite the outer terminal end) the respective piston, a chamber is defined which is intended to contain the working fluid; the volume of the chamber is therefore variable, from a maximum volume (which is reached when the piston is in the upper stroke limit position) to a minimum volume (which is reached when the piston is in the lower stroke limit position).

The ingress of the working fluid to the chamber and the egress therefrom is obtained by way of a feeding/drainage opening, which can be single or multiple for the same chamber, according to requirements.

The extension of the path of the pistons between the upper stroke limit position and the lower position, during the rotation of the cylinder block about its own axis, is obtained by virtue of an abutment element which is facing toward and spaced apart from the cylinder block and inclined with respect to the rotation axis of the cylinder block.

Such abutment element is in fact functionally associated with the free terminal ends of each piston: accordingly, in one complete rotation (meaning 360°) of the cylinder block about its own axis, a piston will describe one complete stroke, for example starting from a lower stroke limit position, reaching the upper one, and then returning to the lower one.

It is to be noted that during a complete rotation of the cylinder block about the second axis, each piston reaches the upper stroke limit position at a first angular position of the cylinder block and the lower stroke limit position at a second angular position of the cylinder block: in particular, when the piston passes the point where the axial distance between the cylinder block and the abutment element is at a minimum, that is the lower stroke limit position, while when the piston passes the point where the axial distance between the cylinder block and the abutment element is at a maximum, that is the upper stroke limit position.

In a bent-axis machine, the abutment element is connected to the transmission shaft, for example provided as a widened plate (or flange) thereof, coupled to or monolithic with the shaft.

The free ends or heads of the individual pistons are arranged in adapted seats in such abutment plate.

The geometric cubic capacity of the machine is defined as the sum of the single geometric cubic capacities of the cylinders/pistons mounted on the cylinder block; the single geometric cubic capacity is, in line with common practice, given by the product of the transverse cross-section of the chamber multiplied by the stroke.

In order to allow the feeding and drainage of the chambers of the pistons consistently with the operating modes of the machine, the latter comprises a distributor which in turn comprises a working fluid distribution circuit at high pressure and a working fluid distribution circuit low pressure.

Such distribution circuits are functionally connected to working fluid lines at high and low pressure which are outside the hydraulic machine, which are in turn functionally connected to high pressure and low pressure fluid sources (e.g. pumps, reservoirs, utilities and the like).

Each distribution circuit comprises a respective opening which extends about the second rotation axis for a corresponding distribution arc, respectively a high pressure working fluid distribution arc and a low pressure working fluid distribution arc.

To this end, such openings usually have a circumferentially slotted shape, also known as “kidney-shaped” in the technical jargon.

The distribution plate is fixed with respect to the rotation axis of the cylinder block, so that, during the rotation of the latter, the feeding/drainage opening of each chamber faces the low pressure or high pressure working fluid distribution arc at certain angular positions: in essence, taking the example of a bent-axis engine and analyzing a chamber of a cylinder that starts from a lower stroke limit position, performs a complete rotation of 360° and returns to the lower stroke limit position, it can be seen that the cylinder chamber is placed in communication first with the high pressure distribution arc, through which the fluid supplies the chamber and causes the exit of the piston and, therefore, the rotation of the cylinder block up until an angular position of the latter rotated by 180° with respect to the initial angular position, i.e. the upper stroke limit position; then the cylinder chamber is placed in communication with the low pressure distribution arc, and as a consequence the higher pressure fluid contained in the chamber exits through the opening of the distributor and the piston can return, allowing the rotation of the cylinder block by another 180° up until the initial angular position.

Returning to the geometric cubic capacity of the machine, this determines its size and the possibility of its being used at different speeds and in determined operation intervals.

In the state of the art it is known to vary, within certain limits, the geometric cubic capacity of the machine, so as to obtain different performance curves.

In particular, the variation of the geometric cubic capacity is obtained (in the state of the art) geometrically, i.e. by varying the stroke of the pistons. In machines of the “bent axis” type, the variation of the stroke of the pistons is obtained by way of varying the existing angle between the cylinder block and the abutment element.

In this way, the maximum extent that the piston reaches at the upper stroke limit position is modified, thus reducing the stroke of the piston and, in the final analysis, the geometric cubic capacity of the machine.

Although functional, this solution for modifying the geometric cubic capacity displays some limitations, however.

One known limitation is linked to the mechanical yield of the hydraulic machine: when the geometric cubic capacity decreases, there is also a perceptible reduction in the mechanical yield of the machine.

Another limitation is linked to the inversion of the direction of motion, which can be useful in some circumstances: if it is desired in fact to invert the direction of rotation of the cylinder block, it becomes necessary to mutually invert the high and low pressure working fluid lines, which makes it necessary to intervene on the hydraulic circuit with an increase in its complexity.

The aim of the present invention consists in providing a bent-axis axial-piston hydraulic machine that solves the above technical problem, eliminates the drawbacks and overcomes the limitations of the known art, making it possible to have a more versatile machine.

Within this aim, an object of the present invention is to provide a bent-axis axial-piston hydraulic machine that always has a high yield, even when the effective cubic capacity is low.

Another object of the invention consists in providing a bent-axis axial-piston hydraulic machine in which the inversion of the direction of motion can be done simply and efficaciously and does not necessitate complex circuit implementations.

Another object of the invention consists in providing a bent-axis axial-piston hydraulic machine that is capable of offering the widest guarantees of reliability and safety in use.

Another object of the invention consists in providing a bent-axis axial-piston hydraulic machine that is relatively easy to implement and economically competitive when compared to the known art.

Another object of the invention consists in providing an alternative bent-axis axial-piston hydraulic machine with respect to machines in the known art.

This aim and these and other objects which will become better apparent hereinafter are achieved by a bent-axis axial-piston hydraulic machine according to the appended first claim and, optionally, according to one or more of the appended dependent claims.

According to the invention each distribution arc is in fluid communication with the variable-volume chamber of at least one cylinder assembly during a passage of that cylinder assembly at at least one section of the extension and return semi-circumferences, the machine comprising means of angular offsetting for mutually angularly offsetting said extension and return semi-circumferences with respect to said first and second distribution arc.

Advantageously, with reference for example to the extension stroke of a piston (from the lower stroke limit to the upper) which is performed during the rotary motion of the piston about the second rotation axis, by way of the invention the variable-volume chamber provided between the cylinder and the piston is placed in communication, for a certain section, with the low pressure working fluid distribution arc and for another (remaining) section with the high pressure working fluid distribution arc.

It is to be noted that, on the contrary, as described above, in the known art, during the extension stroke of the piston, the chamber was always in communication with a single source of fluid (high pressure for use as an engine and low pressure for use as a pump); conversely, again in the known art, during the return stroke of the piston (from the upper stroke limit to the lower) the chamber thereof was always in communication with only one source of fluid (low pressure for use as an engine and high pressure for use as a pump). Therefore we can say that (in the state of the art) during a stroke (extension or return) of the piston, its chamber is always in fluid communication with the same distribution opening (high or low pressure).

An extreme case is constituted by the presence of advance “slottings”, i.e. passage channels of reduced cross-section which are connected with the two distribution openings; in this case, slottings of different distribution openings may be immediately adjacent: in this solution, when the chamber passes at the end point of one slotting and at the start point of the adjacent slotting, corresponding to the upper and lower stroke limit of the piston, it can happen that, locally and at that moment, the chamber is in communication with both fluid sources.

Therefore we can say that (in the state of the art), during a stroke (extension or return) of the piston, its chamber is always in fluid communication with the same distribution opening (high or low pressure) excluding the slottings where, only for an instant and proximate to the dead centers, they may be present, even if for different purposes.

By contrast, in the invention, during a stroke (extension or return) of the piston, its chamber is in fluid communication first with one and then with the other distribution opening (high or low pressure) at least for a section of that stroke.

Brilliantly, this solution enables an operation that is entirely similar to that of a machine in which a reduction in geometric cubic capacity is effected, but without the drawbacks associated with it.

In other words by virtue of the invention a reduction of the effective cubic capacity is obtained while keeping the geometric cubic capacity constant.

Consistently, another object of the invention is a method for adjusting a bent-axis axial-piston hydraulic machine wherein a variation of effective cubic capacity is caused while a geometric cubic capacity is kept constant; optionally and advantageously the variation of effective cubic capacity is obtained by way of an angular offset between the extension and return semi-circumferences with respect to the first and second distribution arc.

The term “effective cubic capacity” as used here means that part of the geometric cubic capacity that corresponds to the volume of fluid that, at each rotation of the motion transmission shaft, is effectively transferred from one line (for example low pressure) to another (for example high pressure).

Further characteristics and advantages of the invention will become better apparent from the description of two preferred, but not exclusive, embodiments of a bent-axis axial-piston hydraulic machine, which are illustrated by way of non-limiting example with the assistance of the accompanying drawings wherein:

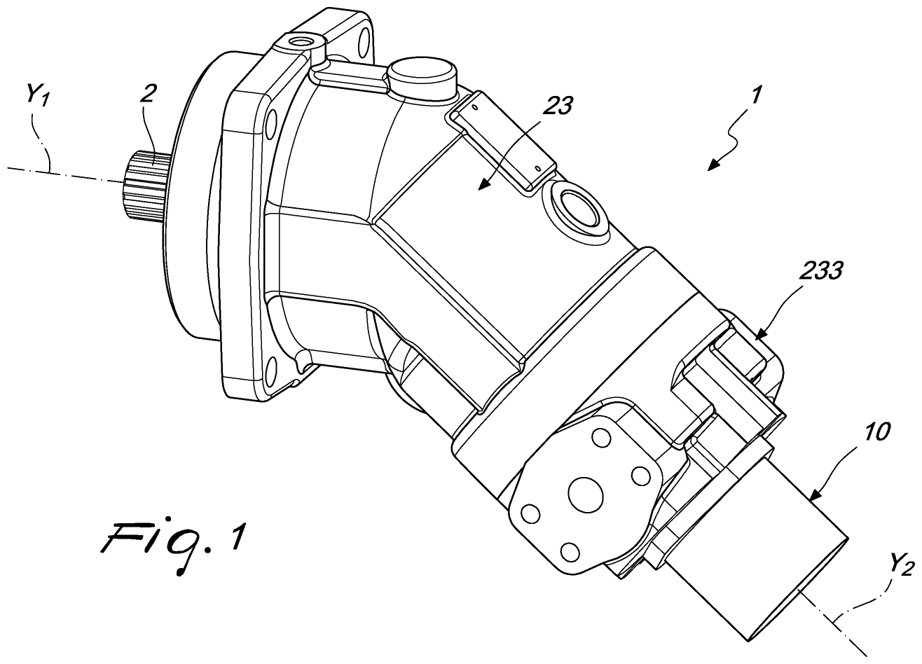

FIG. 1 is a perspective view of a bent-axis axial-piston hydraulic machine according to the invention;

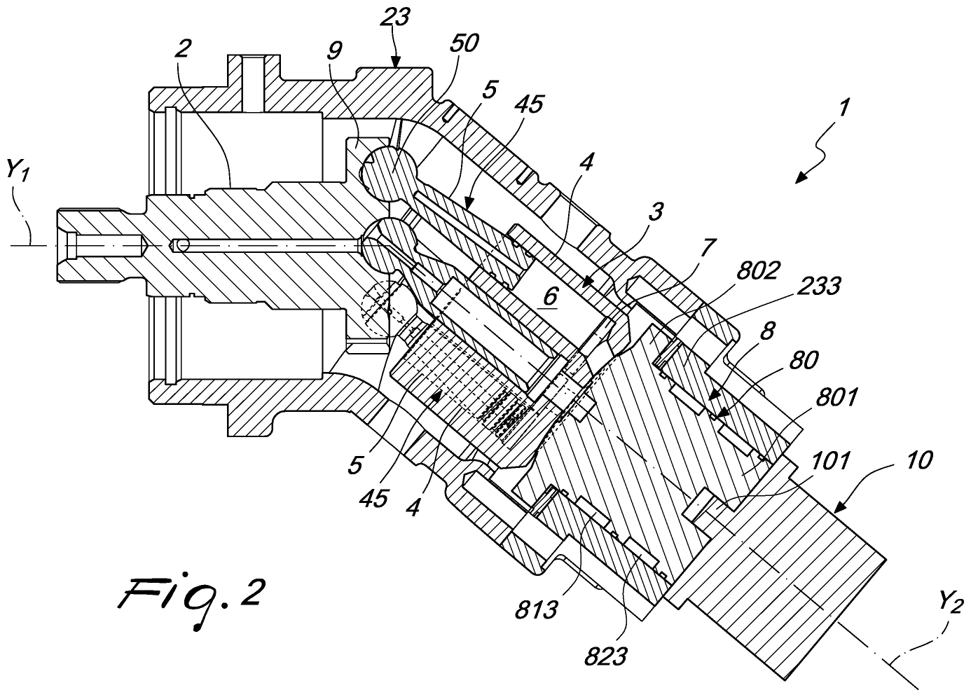

FIG. 2 is a cross-sectional view taken along a longitudinal plane of the machine in FIG. 1;

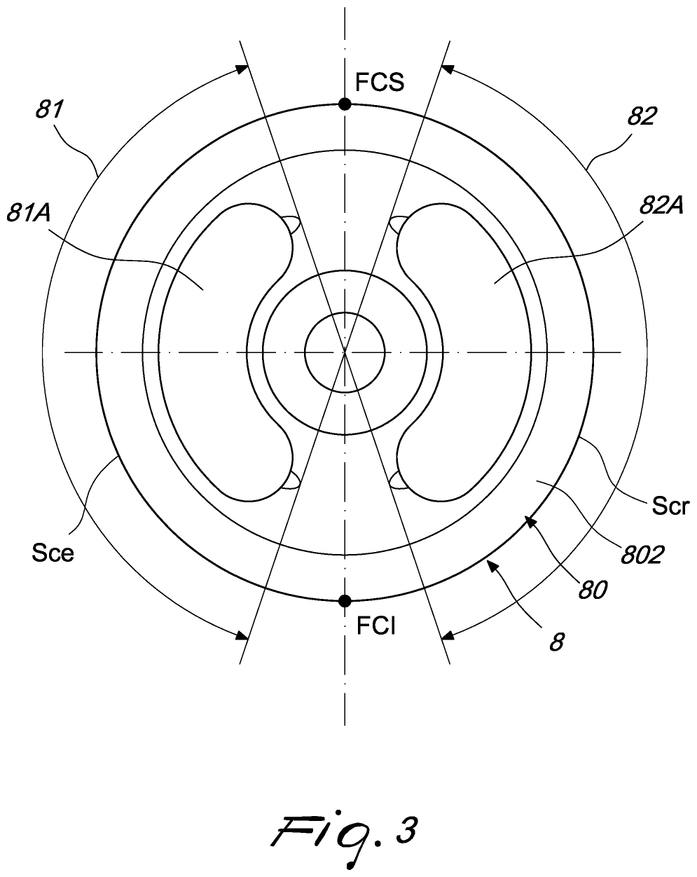

FIG. 3 is a schematic plan view that illustrates a principle of operation of the machine according to the invention;

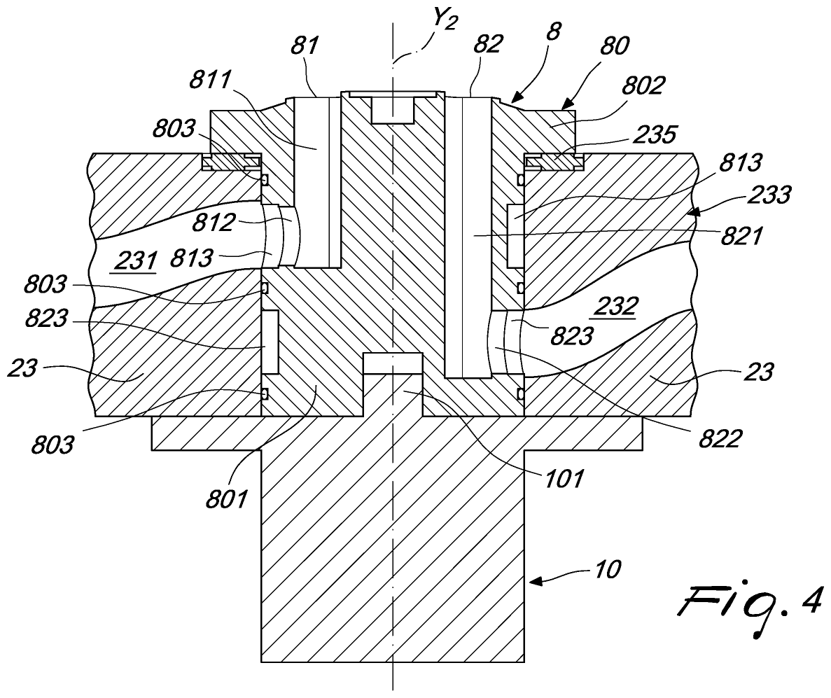

FIG. 4 is a cross-sectional view of part of the machine in FIG. 1 or 2;

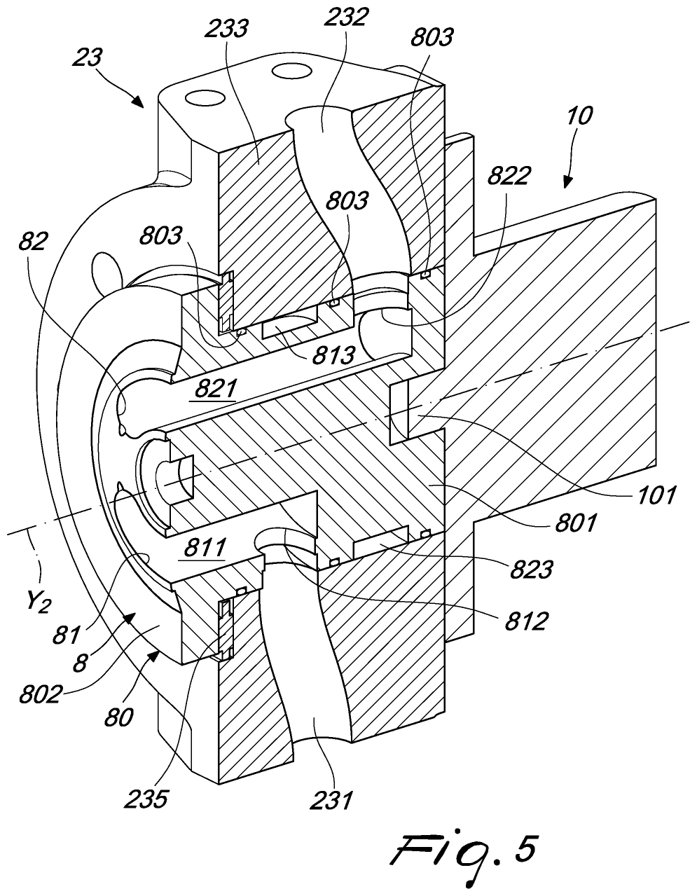

FIG. 5 is a cross-sectional perspective view of the machine part in FIG. 4;

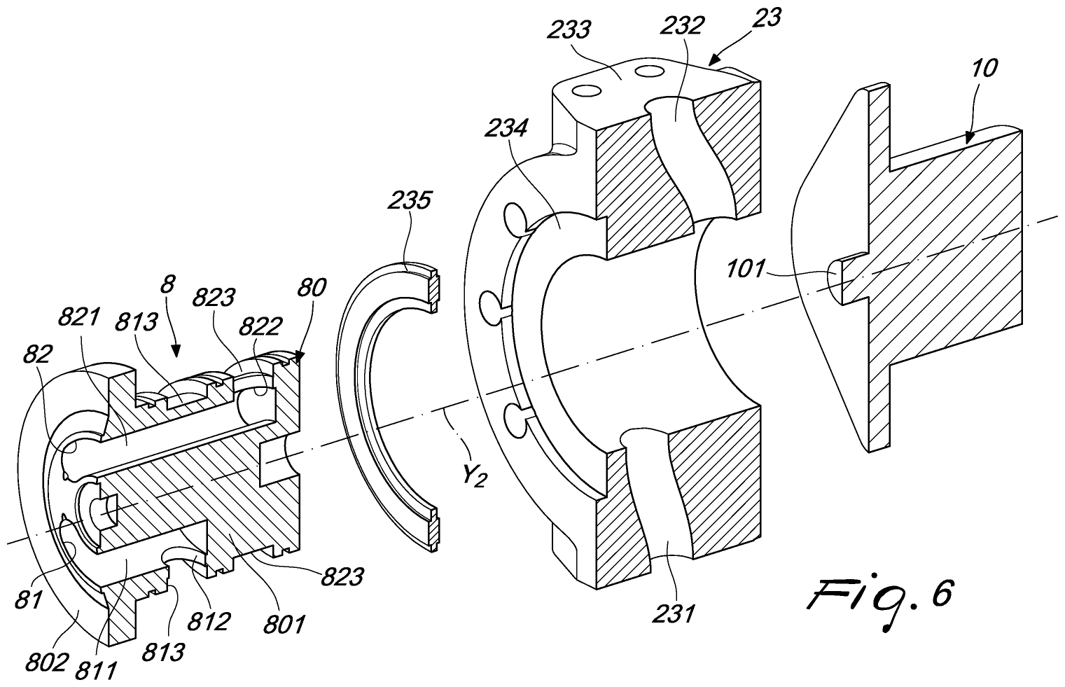

FIG. 6 is an exploded perspective view of FIG. 5;

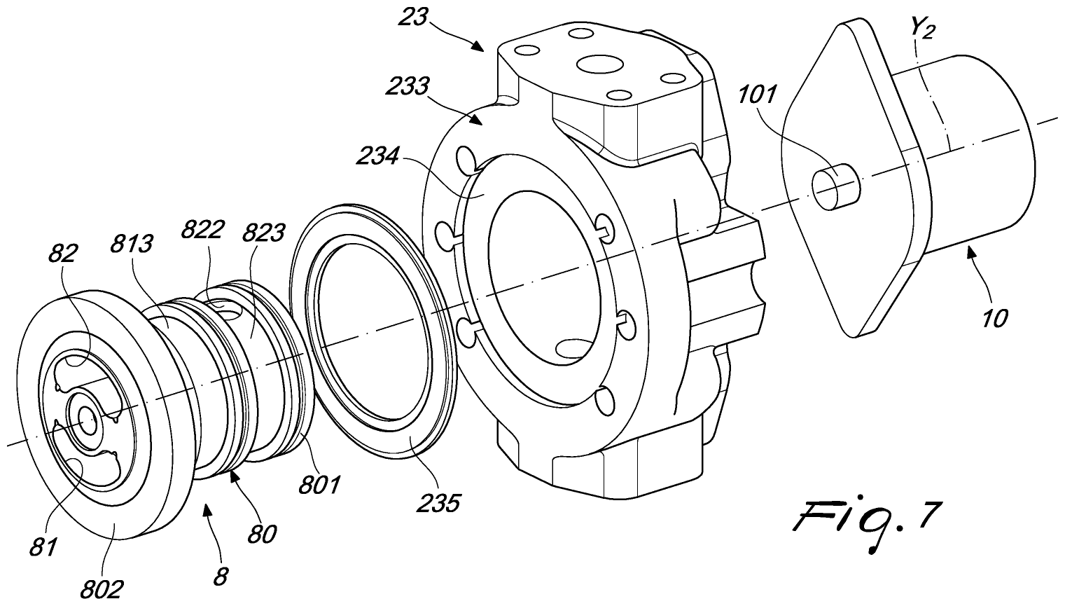

FIG. 7 is an exploded perspective view of the machine part in

FIG. 4, not seen in cross-section.

Although the invention is susceptible of various changes and alternative constructions, a preferred embodiment is shown in the drawings and is described below in detail.

It should be understood, however, that there is no intention of limiting the invention to the specific embodiment shown, but, on the contrary, it is intended to cover all the changes, alternative constructions, and equivalents that fall within the scope of the invention as defined in the claims.

The use of “for example”, “etc.”, and “or” indicates non-exclusive and non-limiting alternatives, unless otherwise indicated.

The use of “includes” means “includes, but non limited to”, unless otherwise indicated.

Indications such as “vertical” and “horizontal”, “upper” and “lower” (in the absence of other indications) must be read with reference to the assembly (or operating) conditions and with reference to the normal terminology in use in the current language.

With reference to the figures, these show an embodiment of the invention applied to a machine of the “bent axis” type, which is generally designated with the reference numeral 1.

Generally these machines are of the piston hydraulic type and they have a transmission axis Y1 and a rotation axis Y2 which do not coincide: the two axes lie on the same plane, but are mutually inclined and incident, as can be seen in FIG. 2.

The machine 1 comprises a transmission shaft 2 which can rotate about the transmission axis Y1, which is inclined with respect to the rotation axis Y2. If the machine 1 operates as an engine, then the transmission shaft 2 acts as an output shaft, while if the machine 1 operates as a pump, then the transmission shaft 2 acts as an input shaft.

The machine 1 comprises at least one and preferably a plurality of cylinder assemblies 45, each one with at least one cylinder 4 and a cooperating piston 5 which between them define a variable-volume chamber 6.

Each cylinder assembly 45 (one or more than one, as in the case shown by way of example) is moveable circumferentially about the rotation axis Y2. Each cylinder assembly 45 is preferably part of a cylinder block 3 inside which the individual cylinders 4 are defined; the cylinder block 3 has a substantially cylindrical shape structure and can rotate about the rotation axis Y2, which is arranged centrally with respect to the cylinder block 3, the cylinder assemblies 45 being arranged at a certain radial distance from the axis Y2; with this implementation the rotation of the cylinder block 3 about the axis Y2 produces a similar rotation of the individual cylinder assemblies 45 about the same axis Y2.

The transmission shaft 2 is functionally associated with the cylinder block 3 for the transmission of rotation between the transmission axis Y1 and the rotation axis Y2; preferably the coupling occurs by way of the abutment plate 9 which is provided with receptacles for the free ends 50 of the pistons 5; we will return to this aspect later.

During one complete rotation of a cylinder assembly 45 about the rotation axis Y2, the following are defined:
an extension semi-circumference Sce, in which the piston 5 follows an extension stroke from a lower stroke limit position to an upper stroke limit position,
a return semi-circumference Scr, in which the piston 5 follows a return stroke from an upper stroke limit position to a lower stroke limit position.

The machine 1 further comprises a distributor 8 which is provided with:
a first distribution circuit of a fluid at a first pressure, which comprises a first distribution arc 81 which is configured to be placed in fluid communication with the variable-volume chamber 6 of at least one cylinder assembly 45 during a pass of that assembly at the first distribution arc 81, and
a second distribution circuit of a fluid at a second pressure, different from the first pressure, which comprises a second distribution arc 82 which is configured to be placed in fluid communication with the variable-volume chamber 6 of at least one cylinder assembly 45 during a passage of that assembly at the second distribution arc 82.

The first and the second distribution arc 81 and 82 extend about a central axis which coincides with the rotation axis Y2 along respective separate angular sectors of the distributor 8.

Detailed views of the distributor 8, cross-sectional and otherwise, are given in FIGS. 4-6, while a schematic plan view can be seen in FIG. 3.

Preferably, as in the example in the accompanying figures, the distribution arcs 81 and 82 each comprise a single slotted distribution opening 81A for the first arc and 82A for the second arc; therefore in the non-limiting embodiment shown the distribution arcs 81 and 82 coincide with the respective distribution openings 81A and 82A.

In alternative embodiments, not shown, each distribution arc (or at least one of them) comprises a plurality of openings distributed to form the respective distribution arc.

The variable-volume chamber 6 comprises a feeding/drainage opening 7 which faces toward the distributor 8, so that during the movement of the corresponding cylinder assembly 45 it opens alternately onto one or the other arc 81, 82 and/or onto the openings 81A, 82A thereof.

In the machine 1 each distribution arc 81, 82 is in fluid communication with the variable-volume chamber 6 of at least one cylinder assembly 45 during a passage of that cylinder assembly 45 at at least one section of the extension and return semi-circumferences.

To this end the machine 1 comprises means of angular offsetting 10 which are functionally associated with the distributor 8 in order to rotate the first and the second distribution circuit about the rotation axis Y2, so as to mutually angularly offset the first 81 and the second distribution arc 82 with respect to the extension Sce and return Scr semi-circumferences.

Advantageously the first and the second distribution circuit are configured to be stably connected to respective operating lines (not shown) for the passage of the fluid at the first and at the second pressure.

The expression “stably connected” means that the first and second distribution circuits are adapted to remain in fluid communication with the respective operating lines independently of the angular configuration assumed by the distributor 8 by virtue of the rotation imparted by the offsetting means 10 about the rotation axis Y2, i.e. in order to maintain the distribution circuits in fluid communication with the respective operating lines during a complete rotation of 360° of the distributor 8 about the rotation axis Y2.

The angular offsetting means 10 are connected to the distributor 8.

The offsetting means 10 in the preferred and non-limiting embodiment illustrated entail a drive means provided with an output gudgeon pin 101 which rotates about the rotation axis Y2, and which is keyed integrally in rotation with a body 80 of the distributor 8. Such drive means is preferably an electric motor, or alternatively a hydraulic motor, or indeed, in particularly simplified solutions, a manual crank drive.

The gudgeon pin 101 and the distributor 8 can rotate together about the rotation axis Y2 inside the body or case 23 of the machine 1.

In particular the body 23 comprises a collar 233, fixed with respect to the body 23 (or monolithic with it), inside which the body 80 of the distributor 8 is supported so that it can rotate about the rotation axis Y2. The body 80 comprises at its opposite free ends a substantially cylindrical shank 801 and a flange 802 which is adapted to be directed toward the cylinder block 3.

The distribution openings 81A and 82A are defined at the flange 802, on the face thereof that is directed toward the cylinder assembly.

A first and a second fluid passage 231 and 232, fixed with respect to the distributor 8, are provided in such collar 233 for connection respectively to the first and to the second operating line.

In more detail, the first distribution circuit comprises the first distribution arc 81 with the corresponding first distribution opening 81A, a first channel 811 passing inside the body 80 of the distributor 8 which extends from the first arc up to a first port 812 for placing in fluid communication with the first passage 231 which opens at the lateral wall of the shank 801. Preferably the first channel 811 has a longitudinal extension through the body 80.

Advantageously the first port 812 and the first passage 231 are placed in communication through a first annular chamber 813 which extends about the rotation axis Y2 on an angle of 360°.

Preferably the first port 812 and the first passage 231 are arranged facing radially, such that the first chamber 813 is directly interposed between them; in this manner it is ensured that, irrespective of the rotation of the distributor about the axis Y2, the passage 231 is always in fluid communication (therefore, stably) with the opening 81.

In the embodiment shown the first chamber 813 is defined by an annular groove which is provided on the lateral wall of the shank 801. The possibility is not ruled out, however, that the first chamber could be defined completely or partially by a groove defined inside the collar 233.

Again, the second distribution circuit comprises the second distribution arc 82 with the corresponding second distribution opening 82A, a second channel 821 passing inside the body 80 of the distributor 8 which extends from the second arc up to a second port 822 for placing in fluid communication with the second passage 232 which opens at the lateral wall of the shank 801. Preferably the second channel 821 has a longitudinal extension through the body 80.

Advantageously the second port 822 and the second passage 232 are placed in communication through a second annular chamber 823 which extends about the rotation axis Y2 on an angle of 360°.

Preferably the second port 822 and the second passage 232 are arranged facing radially, such that the second chamber 823 is directly interposed between them; in this manner it is ensured that, irrespective of the rotation of the distributor about the axis Y2, the passage 232 is always in fluid communication (therefore, stably) with the opening 82.

In the embodiment shown the second chamber 823 is defined by an annular groove which is provided on the lateral wall of the shank 801. The possibility is not ruled out, however, that the second chamber could be defined completely or partially by a groove defined inside the collar 233.

It should be noted that the openings 812 and 822 and the corresponding annular chambers 813 and 823 are provided preferably on the outer face of the shank 801, axially staggered (along the axis Y2) in order to not interfere with each other.

In substance, between the body of the distributor 80 and the collar 33 a form of two ways rotating hydraulic joint is defined.

Between the side wall of the body 80 and the internal wall of the collar 233, sealing rings 803 are spaced at regular intervals between the chambers 813 and 823.

Likewise, a gasket seal 235 is interposed between the flange 802 and the corresponding abutment seat 234 on the collar 233.

Assuming that each distribution arc is connected to a different source of working fluid, for example a high pressure fluid source for the arc 82 and a low pressure source for the arc 81, it follows that, by making the distributor 8 rotate to a position in which the distribution arcs do not coincide with the extension or return semi-circumferences:
during the extension phase of the piston (semi-circumference Sce), starting from the dead center or lower stroke limit FCI, the variable-volume chamber 6 is open: first onto the high pressure working fluid distribution arc 82 and then onto the low pressure working fluid distribution arc 81
during the return phase of the piston (semi-circumference Scr), starting from the dead center or upper stroke limit FCS, the variable-volume chamber 6 is open: first onto the low pressure working fluid distribution arc 81 and then onto the high pressure working fluid distribution arc 82.

This relative offset means that the machine 1, although it does not vary its geometric cubic capacity, behaves like a machine with smaller cubic capacity.

It is to be noted that, incidentally and with reference to the schematic FIG. 3, in machines according to the known art a certain distribution arc (81 or 82) was substantially coincident with or in any case completely superimposed on a single semi-circumference (Sce or Scr), especially if the extreme cases associated with the slottings are excluded; in conventional machines, in fact, the distribution was aligned, in phase, with the stroke (extension or return) of the piston and, in order to vary the performance levels of the engine (or of the pump), it was necessary to vary the geometric cubic capacity.

By contrast, in the present invention the stroke of the piston is kept constant and a variation of the operating parameters of the machine is obtained by offsetting the distribution arcs 81 and 82 with respect to the strokes (extension or return) of the piston; thus the effective cubic capacity is varied while the geometric cubic capacity remains constant.

Furthermore, in the present invention, by rotating the distributor 8 by an angle of 180° it is possible to obtain an inversion of the direction of rotation of the machine 1.

In particular, in the passage of the cylinder assembly 45 along at least one of the extension semi-circumference Sce or the return semi-circumference Scr, the variable-volume chamber 6 is placed in fluid communication first with a portion of one distribution arc and then with a portion of the other distribution arc.

In the machine 1, in the passage of the cylinder assembly 45 along at least one of the extension or return semi-circumferences, the variable-volume chamber 6 is (or, optionally alternatively, can be) placed in fluid communication first with a portion of one distribution arc and then with a portion of the other distribution arc 81, 82.

The cylinder block 3 of the at least one cylinder assembly 45 can rotate about the rotation axis Y2 and is integral in rotation with the transmission shaft 2, by virtue of the fact that the seats for the heads 50 (free ends) of the pistons 5 are accommodated in special recesses provided on a widened base of the shaft 2 which in this example provides the abutment plate 9 which is inclined with respect to the cylinder block 3. In alternative embodiments (not shown), the plate 9 is a separate component from the shaft 2 but to which it is coupled at least in rotation.

With regard to the cylinder block 3, in this case too each cylinder assembly 45 is mounted integral with it, parallel to the rotation axis Y2.

Each cylinder assembly 45 extends between the cylinder block 3 and the abutment plate 9, so as to cause the extension or return of the piston 5 in the cylinder 4 as a function of the axial distance between the cylinder block 3 and the abutment plate 9.

As described above, the means of angular offsetting 10 are adapted to actuate rotationally the distributor 8 about the rotation axis Y2, thus modifying its angular orientation with respect to the abutment plate 9 as well.

Turning now to analyze the variable-volume chamber 6, this comprises a feeding/drainage opening 7 which is directed toward the distributor 8 so as to face, in the rotation of the assembly 45, toward the first 81 or the second distribution arc 82, opening onto it and allowing the ingress/egress of the working fluid to/from that chamber 6 from/to the first/second operating line.

Therefore, as has been seen and as is derived from the foregoing description, the invention also relates to a method for adjusting a hydraulic machine 1 in such method a variation of effective cubic capacity of the machine 1 being caused while a geometric cubic capacity is kept constant.

Preferably, the variation of effective cubic capacity is obtained by way of an angular offset between the extension Sce, Sce′ and return semi-circumferences Scr, Scr′ with respect to the first 81 and second distribution arc 82.

The machine thus conceived is susceptible of numerous modifications and variations all of which are within the scope of the appended claims. Moreover, all the details may be substituted by other, technically equivalent elements.

In practice the materials employed, provided they are compatible with the specific use, and the contingent dimensions and shapes, may be any according to requirements.

The disclosures in European Patent Application No. 18425015.7 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-13. (canceled)

14. A bent-axis axial-piston hydraulic machine that comprises:
a cylinder block that comprises a plurality of cylinder assemblies, each one with at least one cylinder and a cooperating piston that define between them a variable-volume chamber, said at least one cylinder assembly being movable circumferentially about a first rotation axis,
in which in one complete rotation of a cylinder assembly about the rotation axis, the following are defined:
an extension semi-circumference, in which the piston follows an extension stroke from a lower stroke limit position to an upper stroke limit position and
a return semi-circumference, in which the piston follows a return stroke from an upper stroke limit position to a lower stroke limit position,
a transmission shaft which is functionally associated with said cylinder block and which can rotate about a transmission axis incident on said rotation axis and
a distributor which in turn comprises:
a first fluid distribution circuit at a first pressure, which comprises a first distribution arc which is configured to be placed in fluid communication with the variable-volume chamber of at least one cylinder assembly during a passage of said cylinder assembly at the first distribution arc, and
a second fluid distribution circuit at a second pressure, different from the first pressure, which comprises a second distribution arc which is configured to be placed in fluid communication with the variable-volume chamber of at least one cylinder assembly during a passage of said cylinder assembly at the second distribution arc,
in which the first and the second distribution arc extend about a central axis which coincides with the rotation axis
wherein the machine comprises an angular offsetting device which is associated with said distributor in order to rotate the first and the second distribution circuit about said rotation axis, so as to mutually angularly offset said extension and return semi-circumferences with respect to said first and second distribution arc, the first and the second distribution circuit being configured to be stably connected respectively to a first operating line of fluid at the first pressure and to a second operating line of fluid at the second pressure.

15. The hydraulic machine according to claim 14, wherein, in the passage of the cylinder assembly along at least one of the extension or return semi-circumferences, the variable-volume chamber is placed in fluid communication first with a portion of one distribution arc and then with a portion of the other distribution arc.

16. The hydraulic machine according to claim 14, wherein said angular offsetting device comprises a drive device for rotary actuation which is coupled to the distributor in order to rotate it about said rotation axis with respect to the cylinder block.

17. The hydraulic machine according to claim 14, wherein the first distribution arc and the second distribution arc each comprise a curved slotted opening, which extends around said rotation axis, and wherein the first distribution arc is a working fluid distribution arc at a first pressure and the second distribution arc is a working fluid distribution arc at a second pressure, different from the first pressure.

18. The hydraulic machine according to claim 14, wherein the variable-volume chamber comprises a feeding/drainage opening which faces toward the distributor in order to be opened toward the first or the second distribution arc.

19. The hydraulic machine according to claim 14, wherein said transmission shaft comprises an abutment plate of the head of the piston of said at least one cylinder assembly, the distributor and the abutment plate being able to rotate with respect to each other about the rotation axis.

20. The hydraulic machine according to claim 14, wherein said angular offset between said extension and return semi-circumferences with respect to said first and second distribution arc causes a variation of effective cubic capacity.

21. The hydraulic machine according to claim 14, wherein said machine comprises a body which is provided with a collar inside which said distributor is supported so that it can rotate about said rotation axis, inside said collar a first and a second fluid passage being defined for placing in communication respectively with the first and with the second operating line.

22. The hydraulic machine according to claim 21, wherein each one of said first and second distribution circuits comprises a respective first or second channel which passes inside said distributor and extends from the first or second distribution arc to a first or second port for placing in communication with said first or second passage which opens laterally to the distributor.

23. The hydraulic machine according to claim 22, wherein said machine comprises an annular chamber which is interposed between each one of said first or second ports and the respective first or second passage, the annular chamber extending along a complete circumference centered on the rotation axis.

24. The hydraulic machine according to claim 23, wherein said annular chambers are defined by respective annular grooves which are provided on said distributor and are arranged axially staggered.

25. A method for adjusting a hydraulic machine according to claim 14, wherein a variation of effective cubic capacity is caused while a geometric cubic capacity of said machine remains constant.

26. The method for adjusting a hydraulic machine according to claim 25, wherein the variation of effective cubic capacity is obtained by way of an angular offset between said extension and return semi-circumferences with respect to said first and second distribution arc.
